(19) United States
(12) Patent Application Publication
(10) Pub. No.: US 2013/0080535 A1
(43) Pub. Date: Mar. 28, 2013

(54) SYSTEM AND METHOD FOR COLLABORATIVE INFORMATION SERVICES

(71) Applicants: Jerome Rolia, Kanata (CA); Steven J. Simske, Ft. Collins, CO (US); Mark Jacobsen, Galway (IE); Gary Moloney, Galway (IE)

(72) Inventors: Jerome Rolia, Kanata (CA); Steven J. Simske, Ft. Collins, CO (US); Mark Jacobsen, Galway (IE); Gary Moloney, Galway (IE)

(21) Appl. No.: 13/701,866

(22) PCT Filed: Jun. 30, 2010
(86) PCT No.: PCT/US10/40608

§ 371 Date: Dec. 4, 2012

(51) Int. Cl. G06F 15/173

(52) U.S. Cl. CPC G06F 15/17306
USPC 709/204; 709/225

(57) ABSTRACT

The present disclosure includes a system and method for collaborative information services. A computing system includes a plurality of collaborative information participants [238] interconnected via a communication network [239], each participant having zero or more data sources [240], and a computing platform [224] programmed with query services [226]. Each query service defines one or more queries [227-1, 227-2, . . . 227-N] operable on authorized portions of participant data sources [240]. The computing platform [224] is further programmed with indications from individual ones of the plurality of collaborative information participants [238] authorizing some portion of their data source [240] to be available to the one or more queries [227-1, 227-2, . . . , 227-N] defined by at least one query service [226].

### CROSS REFERENCE TO RELATED APPLICATIONS

The present application is related to (1) PCT Application serial number ______, attorney docket number 201000505-1, entitled “System and Method for Service Recommendation Service,” filed on the same date as the present application, (2) PCT Application serial number ______, attorney docket number 201000504-1, entitled “System and Method for Serialized Data Service,” filed on the same date as the present application, (3) PCT Application serial number ______, attorney docket number 201000503-1, entitled “System and Method for Automated Data Discovery Service,” filed on the same date as the present application, and (4) PCT Application serial number ______, attorney docket number 201000497-1, entitled “System and Method for Self-Service Configuration of Authorization,” filed on the same date as the present application, the disclosures which are incorporated herein by reference.

### BACKGROUND

Information can have great value. Assembling and maintaining a database to store information involves real costs. The costs can include the costs to acquire the information, the costs associated with the physical assets used to house, secure, and make the information available, and/or the labor costs to manage the information.

Some of the value of certain information may be derived from the fact that the information is not widely known (e.g., not shared). For example, a list of suppliers, their products and pricing, or a customer list, may be valuable to a manufacturing entity, which likely would not be inclined to share such information with its competitors. Conversely, some of the value of other information may be derived from the fact that the information is widely known (e.g., shared). For example, a library catalog is information that can be valuable to a community of users by being widely available, thereby saving time, effort, and perhaps money in trying to locate a particular item in a collection of items.

Some competitive information that principally derives value from not being widely known (e.g., among competitors and/or customers) may derive additional value were it shared with other entities in a limited manner. One such example is information related to a supply chain. A supply chain is a system of organizations, people, technology, activities, information and resources involved in moving a product or service from supplier to customer. Relationships of participants in a supply chain may include supplier-customer, and/or competitors, among others. Regulators and/or consumers may also have an interest in information concerning a particular supply chain. For example, information regarding the supply chain of a food product may be of interest to regulators and/or consumers.

It may be beneficial to share information on a limited basis to demonstrate that a certain component is not involved, or otherwise trace items and/or processes involved in the supply chain. It may be desirable to share information on a limited basis for studies that might benefit multiple supply chain entities and/or the consumers, or to prove or disprove some fact to regulators. Increased traceability can also limit the potentially huge economic and safety consequences of counterfeiting and defective products. For example, global food and/or brand name piracy concerns can cost the industry billions of dollars each year, and can cause the industry to implement anti-counterfeit technologies to protect products, brand, and/or market. Recall is also a critical service where remedial activities are to be applied to a defective product or component thereof, making it desirable to identify locations of the affected product. Increased traceability along a supply chain can increase trust and limit the consequences of events closer to their source in a supply chain.

Enhanced supply chain robustness improves customer experience by delivering products reliably and decreasing the costs and manual effort associated with debugging and fixing errors in the delivery of products and services. Supply chain participants are motivated to improve robustness but need improved mechanisms to efficiently manage the sharing of information.

### BRIEF DESCRIPTION OF THE DRAWINGS

FIG. 1 is a diagram illustrating a computing system according to an example of the present disclosure.

FIG. 2A is a diagram illustrating an example computing platform for providing collaborative information services according to an example of the present disclosure.

FIG. 2B is a diagram illustrating another example computing platform for providing collaborative information services according to an example of the present disclosure.

FIG. 3 is a diagram illustrating components of the collaborative information services platform according to an example of the present disclosure.

FIG. 4 is a diagram illustrating an authorization and attestation service for a computing platform according to an example of the present disclosure.

FIG. 5 is a diagram illustrating a discovery service for a computing platform according to an example of the present disclosure.

FIG. 6 is a diagram illustrating a cloud index cache arrangement according to an example of the present disclosure.

FIG. 7 is a flow chart illustrating an example of a method for a collaborative information system according to an example of the present disclosure.

### DETAILED DESCRIPTION

The present disclosure includes a system and method for collaborative information services. A computing system includes a plurality of collaborative information participants interconnected via a communication network, each participant having a data source, and a computing platform programmed with query services. Each query service defines one or more queries operable on authorized portions of participant data sources. The computing platform is further programmed with indications from individual ones of the plurality of collaborative information participants authorizing some portion of their data source to be available to the one or more queries defined by at least one query service.

The collaborative information system of the present disclosure is arranged generally in a hub-and-spokes configuration, with a collaborative information services (CIS) computing platform programmed with query services as a hub, and participant data sources as the spokes. Participants in the collaborative information system make some portion of their respective data sources available to queries of other participants. According to the present disclosure, participants authorize query services with constrained data inputs and known output attributes. A query service is a group of one or more queries executed to ascertain information of interest. A query set is a number of queries that can be related to one another in some aspect. A query service may include queries from one or more query sets, or the queries comprising multiple query services may all be included in a single query set. That is, a query service may be a subset of one or more query sets, or multiple query services may be subsets of a single query set, depending on the queries comprising the query set(s) and the query service(s).

According to the collaborative information system of the present disclosure, attributes of each query service are defined prior to the query service being invoked by any participant. Each data source controlling entity must implement pre-defined queries of a query service to involve their respective data source. For example, the type of data and scope of data sources associated with a particular query service is predefined, the attributes of a respective query service being made available to participants so that they can determine whether, and to what extent, to expose their respective data source to the queries of a query service. That is, each query service is implemented using a “canned” group of queries that can be applied to a data source, if authorized by the control entity of the data source and the queries implemented on the respective data source. Similarly, scope, format, etc., of query results are also defined prior to a query service being invoked. Such a pre-defined result may be computed and mutually advantageous for the query invoker and data providers to share. It may obfuscate aspects of the data obtained by the embedded queries to compute intermediate results but that the data providers may not want or need to share directly. This may encourage providers to share more data with the knowledge that those invoking query services only have access to the possibly more limited computed results. Having pre-defined queries in terms of inputs and outputs enables collaborative information system participants to make informed decisions as to the type and extent of queries, and therefore query services, to which they are willing to allow their respective data source to be exposed.

According to the collaborative information system of the present disclosure, information needed for authorized results (e.g., raw data source data, intermediate computations, etc.) may, or may not, be presented to the participant that invokes a particular query service. In some previous approaches, the data being made available by each participant needed to be stored (e.g., duplicated to) a particular dedicated computing system storage media. However, the collaborative information system of the present disclosure does not require participant-contributed information to be maintained in a common, dedicated location. That is, the collaborative information system of the present disclosure enables participants to self-configure various authorization models that in turn control access of other participants to their data source(s). In this manner, dispersed data sources, including cloud based data sources, can be controlled to the degree desired by the data source control entity at their original location.

According to the collaborative information system of the present disclosure, authorization to access data of a data source is made with respect to query services of the collaborative information services computing platform, rather than peer-to-peer with each participant in the collaborative information system. Thus, the collaborative information system of the present disclosure enables self-configuration of authorizations by participants with fewer interventions by their IT staff. Also, automated and repeated discovery of information available from portions of the data sources available to the query services supports the efficient implementation of real time query services on a large scale.

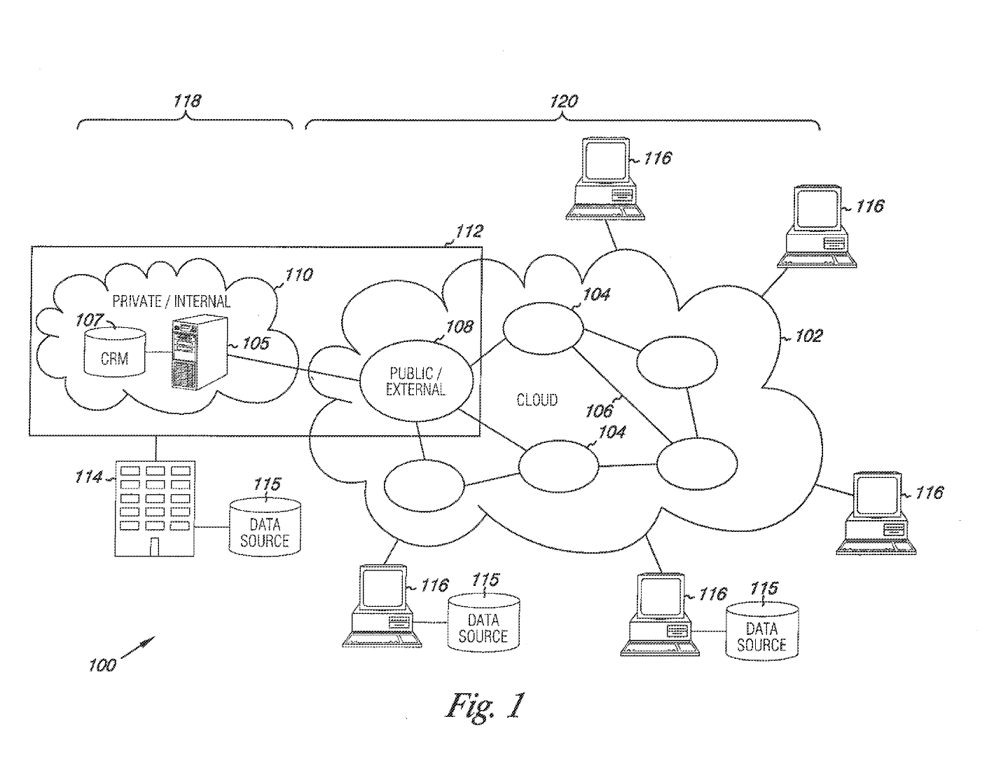

FIG. 1 is a diagram illustrating a computing system according to an example of the present disclosure. The computing system shown in FIG. 1 is a networked computing system, such as a cloud computing system 100. Cloud computing system 100 is one example implementation of a networked computing system. However, examples of the present disclosure are not limited to a particular computing system configuration. By “cloud computing” is meant Internet-based computing that can effectively share physical computing resources, including software and/or information among a number of users. Cloud computing enables fine-grained provisioning of computing resources in real time to achieve dynamic scalability in response to varying data processing levels.

Cloud computing system 100 can include a private cloud 110 communicatively coupled to a public cloud 102. The public cloud 102 can include a number of computing resources 104 networked together by various communication channels 106, including first computing resources 104 external to a hybrid cloud 112 (discussed further below), and second computing resources external to the hybrid cloud 112. The computing resources 104 comprising the public cloud 102 can be of varying size and capability, may be respectively geographically dispersed from one another or be commonly located, and may be respectively owned and/or operated by any number of independent entities. The size, capabilities, and configuration of public cloud 102 can be dynamically changed as dictated by service level agreements, actual computing requirements, and for other factors applicable to cloud computing arrangements.

The term “public” refers to computing resources offered and/or available for use by entities (e.g., the public) other than the computing resource owners, usually in exchange for compensation (e.g., computing capability for hire). Computing resources 104 comprising the public cloud 102 may be owned by discrete entities, which may or may not be participants in a particular collaborative information system for which the computing resources are being employed.

A respective private owner/operator can make owner/operator-maintained computing resources available to the public for hire. The term “private” refers to computing resources dedicated for use by a limited group of users (e.g., one entity such as a company or other organization). That is, “private” is intended to mean reserved for use by some and not available to the public.

The private cloud 110 can be comprised of a number of computing resources 105. While a single server is shown in FIG. 1, the private cloud can be comprised of multiple computing resources 105. A computing resource 105 can include control circuitry such as a processor, a state machine, application specific integrated circuit (ASIC), controller, and/or similar machine. As used herein, the indefinite articles “a” and/or “an” can indicate one or more than one of the named object. Thus, for example, “a processor” can include one processor or more than one processor, such as a parallel processing arrangement. The control circuitry can have a structure that provides a given functionality, and/or execute computer-readable instructions that are stored on a non-transitory computer-readable medium 107. The non-transitory computer-readable medium 107 can be integral, or communicatively coupled, to a computing resource 105, in either in a wired or wireless manner. For example, the non-transitory computer-readable medium 107 can be an internal memory, a portable memory, a portable disk, or a memory located internal to another computing resource (e.g., enabling the computer-readable instructions to be downloaded over the Internet). The non-transitory computer-readable medium can have computer-readable instructions stored thereon that are executed by the control circuitry (e.g., processor) to provide a particular functionality.

The non-transitory computer-readable medium 107, as used herein, can include volatile and/or non-volatile memory. Volatile memory can include memory that depends upon power to store information, such as various types of dynamic random access memory (DRAM), among others. Non-volatile memory can include memory that does not depend upon power to store information. Examples of non-volatile memory can include solid state media such as flash memory, EEPROM, phase change random access memory (PCRAM), among others. The non-transitory computer-readable medium 107 can include optical discs, digital video discs (DVD), high definition digital versatile discs (HD DVD), compact discs (CD), laser discs, and magnetic media such as tape drives, floppy discs, and hard drives, solid state media such as flash memory, EEPROM, phase change random access memory (PCRAM), as well as other types of machine-readable media.

A data source 115 owned by entity 114 (e.g., organization, natural person) can be part of private cloud 110, or as shown in FIG. 1, communicatively coupled to private cloud 110. That is, information under the control of organization 114 may be stored in the computing resources comprising private cloud 110, or be stored in memory accessible by private cloud 110. The data source 115 may be used in a collaborative information system, with organization 114 making some portion of the information stored in data source 115 available to other participants in the collaborative information system, as is further described below.

Although not shown in FIG. 1 for clarity, private cloud 110 can also include a number of computing resources (e.g., physical resources, software, etc.), such as computing resources 104, networked together by various communication channels 106. The computing resources of private cloud 110 can be homogeneous or of varying size and capability, may be geographically dispersed from one another or be commonly located, and may be owned and/or operated by one or any number of independent entities that dedicate some or all of their computing resources for the private use of one entity (e.g., organization 114). The size, capabilities, and configuration of the private cloud can change as dictated by service level agreements, dynamic computing requirements, and other factors applicable to cloud computing arrangements.

A portion 118 of cloud computing system 100 may be owned by organization 114, and another portion 120 of cloud computing system 100 may be owned by entities other than organization 114. As such, in addition to being private, private cloud 110 may be referred to as an internal cloud as well (e.g., a cloud computing arrangement internal to organization 114 and dedicated to the private use of organization 114). Considerations regarding specific cloud computing system configuration may include security, logging, auditing/compliance, firewall boundary location, and/or company policy, among others. Organization 114 may maintain additional computing resources not dedicated to the private use of organization 114 (e.g., available for contract use by the public as part of a cloud).

A number of entities 116 may be users of the public cloud 102 (e.g., as a networked computing system). Some entities 116 may have data sources 115 that may be used in (e.g., made available for query by participants) a collaborative information system, and other entities 116 using the public cloud may participate in the collaborative information system (e.g., invoke queries) but not have, or make available, a data source to other participants. There are many products from a variety of different vendors that can implement data sources that may be used for collaborative information services via standard interfaces for data queries.

While cloud computing system 100 is illustrated in FIG. 1 as two communicatively coupled clouds (e.g., private and public), examples of the present disclosure are not so limited, and the method of the present disclosure can be implemented using a private cloud 110, public cloud 102, or a hybrid cloud 112 comprising some portion of the public cloud 102 and the private cloud 110 made available for such use.

Not all of the components and/or communication channels illustrated in the figures are required to practice the system and method of the present disclosure, and variations in the arrangement, type, and quantities of the components may be made without departing from the spirit or scope of the system and method of the present disclosure. Network components can include personal computers, laptop computers, mobile devices, cellular telephones, personal digital assistants, or the like. Communication channels may be wired or wireless. Computing devices comprising the computing system are capable of connecting to another computing device to send and receive information, including web requests for information from a server. A server may include a server application that is configured to manage various actions, for example, a web-server application that is configured to enable an end-user to interact with the server via the network computing system. A server can include one or more processors, and non-transitory computer-readable media (e.g., memory) storing instructions executable by the one or more processors. That is, the executable instructions can be stored in a fixed tangible medium communicatively coupled to the one or more processors. Memory can include RAM, ROM, and/or mass storage devices, such as a hard disk drive, tape drive, optical drive, solid state drive, and/or floppy disk drive.

The non-transitory computer-readable media can be programmed with instructions such as an operating system for controlling the operation of server, and/or applications such as a web page server. The collaborative information services (CIS) platform and/or applications (e.g., services and/or models) may be implemented as one or more executable instructions stored at one or more locations within volatile and/or non-volatile memory. Computing devices comprising the computing system implementing the collaborative information system may also include an internal or external database, or other archive medium for storing, retrieving, organizing, and otherwise managing data sources and/or the functional logic of the collaborative information system.

Computing devices comprising the computing system may also be mobile devices configured as client devices, and include a processor in communication with a non-transitory memory, a power supply, one or more network interfaces, an audio interface, a video interface, a display, a keyboard and/or keypad, and a receiver. Mobile devices may optionally communicate with a base station (not shown), or directly with another network component device. Network interfaces include circuitry for coupling the mobile device to one or more networks, and is constructed for use with one or more communication protocols and technologies. Applications on client devices may include computer executable instructions stored in a non-transient medium which, when executed by a processor, provide such functions as a web browser to enable interaction with other computing devices such as a server, and/or the like.

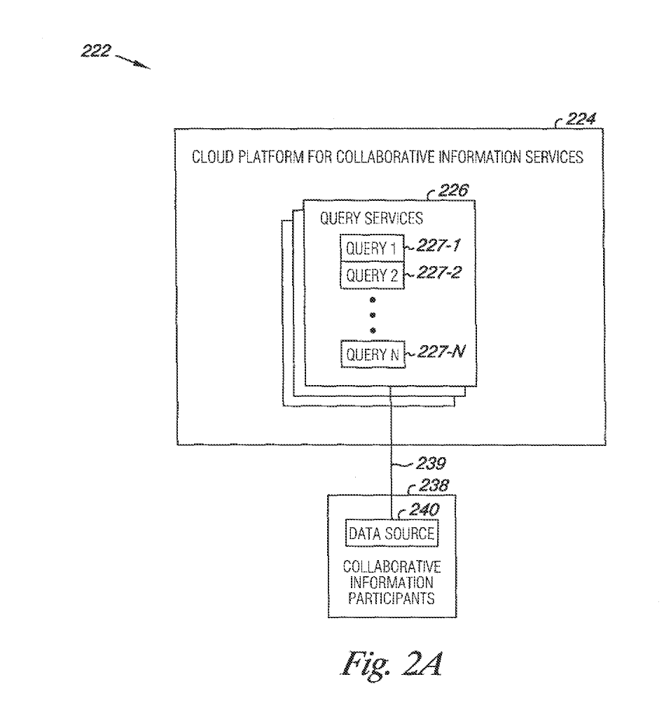

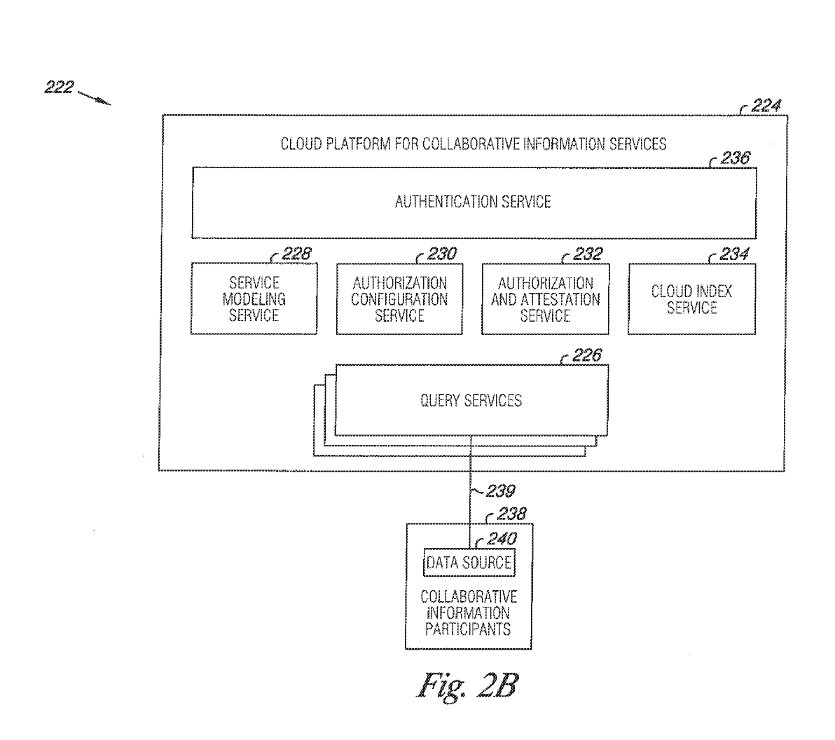

FIG. 2A is a diagram illustrating an example computing platform for providing collaborative information services according to an example of the present disclosure. The systems and methods of the present disclosure for collaborative information services are illustrated throughout this description with respect to a supply chain application of the collaborative information system. However, implementation of the collaborative information system of the present disclosure is not limited to supply chains, and other collaborative information service implementations are contemplated, including SaaS implementations.

Supply chains can involve numerous individual entities located around the world in a global economy. Collaborative efforts to monitor, report, debug, and optimize supply chains that span multiple organizations and countries can be beneficial to supply chain participants and beneficiaries. The biggest barriers to increased collaboration across organizations are lack of trust and the effort needed to scale collaboration efforts. Supply chain information is a critical business asset that can be exploited by competitors. In many cases information is the greatest competitive advantage of an organization.

Networked computing systems can be used to share information (e.g., data) contained in separately-controlled databases. Often, authorization management is not standardized. Database owners can agree to share data with other database owners in a point-to-point, or alternatively a peer-to-peer, manner. Point-to-point agreements regarding database access can be made to facilitate sharing certain information with trusted partner organizations. For example, entity “A” may own and control database “A,” and entity “B” may own and control database “B.” Entity “A” might agree to provide entity “B” certain access rights to the “A” database, often in exchange for entity “B” providing entity “A” some access rights to database “B.”

Point-to-point access arrangements necessitate information technology (IT) resources to manage (e.g., monitor, control, verify, secure, update, modify, etc.) the individual point-to-point authorizations for interaction specific data exchanges. However, this approach does not scale particularly well. Where there are N entities desiring to share access to their respective databases with each of the other entities, N*(N−1)/2 point-to-point sharing arrangements need to implemented and managed. As N becomes large, point-to-point sharing arrangements can involve a rather large IT workload.

Furthermore, when one entity is authorized to access data from another entity's database, there is little control over how the data will be used after it is retrieved, which can encourage data mining and/or affect the value of the database information. The possibility of misusing shared data can hinder the willingness of some entities to share information contained in their respective database with others.

A networked computing system implementing collaborative information services (CISs) can be applied to the information associated with a supply chain to provide a secure and trusted registry for supplier and customer information. Such a collaborative information system can act as a cache for information that connects services, partners, and customers. For example, suppliers may register products they sell with the collaborative information system, and customers may register products they use.

The collaborative information system can be used, for example, to provide a recall service upon a product associated with the supply chain. Information in the collaborative information system can cause recall messages to be sent to specific recipients (e.g., existing customers), rather than be broadcast generally (e.g., sent to potential customers as well). Recall messages can include detailed instructions appropriate for a particular recall, or series of recalls. Such a recall service could record the messages sent so that a supplier has the assurance that registered customers are notified.

A customer may also act as a supplier of a product that includes other products as parts. If one of the parts is recalled, then the customer may issue an additional recall via the collaborative information system for the composite product. In this way recall messages can traverse an appropriate portion of the supply chain without being over-, or under-, inclusive.

FIG. 2A illustrates an example architecture of a collaborative information system 222. For example, some, or all, of the participants in the supply chain of interest can be participants 238 in the collaborative information system 222. Collaborative information system participants 238 may have zero or more data sources 240 (e.g., databases, memory) that may be made available to the collaborative information system 222, and other participants 238 therein. Such data sources 240 can be widely deployed, owned and/or controlled by independent entities, and can be implemented with standard interfaces for sharing supply chain information. Some participants 238 of the collaborative information system 222 may not provide a data source to the collaborative information system 222 (e.g., have zero data sources). Some participants 238 of the collaborative information system 222 may participate by invoking query services without offering a data source. For example, regulators or consumers may be collaborative information system participants 238 without also being data source providers.

The collaborative information system 222 illustrated in FIG. 2A includes a CIS platform 224 communicatively coupled to a plurality of collaborative information participants 238 interconnected via a communication network 239, each participant 238 having a data source 240. According to an example embodiment, the collaborative information system 222 can be implemented by a networked computing system such as the cloud computing system 100 illustrated in FIG. 1, with the CIS platform 224 being implemented as a cloud platform. That is, the CIS platform can be implemented using geographically diverse and dynamically-configured computing resources.

The CIS platform 224 is communicatively coupled to the data sources 240 associated with participants in the collaborative information system via communication link 239. The CIS platform 224 is programmed with CISs 226 (e.g., query services). Each query service 226 is implemented using one or more queries (e.g., 227-1, 227-2, . . . 227-N) operable on authorized portions of participant data sources 240. That is, each CIS can be a set of one or more queries involving the available data sources 240. A group of queries may be the same or different (e.g., more or less inclusive) than a query set, which is discussed further below. In other words, each query service may be implemented using a standardized group (e.g., “canned set”) of queries. The CIS platform 224 is further programmed with indications from individual ones of the plurality of collaborative information participants 238 authorizing some portion of their data source 240 to be available to the one or more queries (e.g., 227-1, 227-2, . . . 227-N) defined by at least one query service 226. Participants 238 can make all or part of their data source available to all or part of a respective query, or query set. A participant 238 may require its IT staff to enable a query or query set. However, once enabled, the participant may then authorize additional query services that already have their required queries implemented without further involvement of the IT staff.

FIG. 28 is a diagram illustrating another example computing platform for providing collaborative information services according to an example of the present disclosure. In addition to the query services 226, the CIS platform 224 can be programmed with a service modeling service 228, an authorization configuration service 230, an authorization and attestation service 232, a cloud index service 234, and an authentication service 236.

The service modeling service 228 describes the queries issued by each query service 226, as well as the attributes (e.g., format, scope) of the output results by a respective query service 226. The authorization configuration service 230 is a portal that allows CIS participants to control the access to their data sources by query services 226 and/or individual queries. The authorization portion of the authorization and attestation service 232 ensures that just authorized queries by authorized query services 226 access participant data sources 240. The attestation portion of the authorization and attestation service 232 logs interactions of the various services and the participant's data sources 240, if desired by a participant 238, to serve as an audit trail. The cloud index service 234 maintains a cache of authorized information from data sources 240 that enable the efficient implementation of query services which require information for just a fraction of the potentially large number of data sources 240.

The CIS platform 224 is programmed (e.g., with executable instructions stored in a memory and executable on a processor) to implement the following functionality. Participants 238 in the collaborative information system 222 authenticate with the CIS platform 224 (e.g., peer-to-platform and platform-to-peer, together referred to as peer-to-platform-to-peer) rather than directly with each other (e.g., peer-to-peer). For example, a first participant 238 can authorize the CIS platform 224 to execute certain query services and/or queries on certain portions of the first participant's data sources 240, providing the query results in certain, specified ways (explained further below). A query service may integrate the data that the query service receives from many data sources to enable the query service to compute a result. The first participant 238 can further authorize the CIS platform 224 to permit certain other participants to invoke the authorized query services (and/or queries) on the authorized portions of the first participant's data sources 240.

Thereafter, another participant 238, if authorized by the platform as a result of the platform being authorized to permit the another participant 238, can cause the CIS platform 224 to invoke an authorized query service 226 (and/or queries). That is, the first participant can authorize a query, a query set, and/or a CIS, to involve portions of the first participant's data sources specified by the first participant corresponding to each query. Subsequently, one or more participant(s), if authorized with respect to the query, or query set and/or a query service, can then execute the query, a query set, and/or a query service, to involve portions of the first participant's data sources that the first participant specified corresponding to a respective query. In this manner, the first participant does not have to individually authorize (and monitor or control) each subsequent participant individually that wishes to execute the query, or query set and/or query service. Provisions are explained below for creating new queries and/or query services (i.e., groups of queries).

The peer-to-platform and platform-to-peer authorization functionality of the CIS platform 224 enables participants 238 to authorize CIS services that access data in standardized (e.g., known) ways instead of having to manage point-to-point data sharing rules among participants that can be typical of previous information sharing approaches. The peer-to-platform and platform-to-peer authorization relationship structure, effectively a hub-and-spokes configuration, enables greater scalability from the perspective of managing the collaborative information system arrangements. The peer-to-platform and platform-to-peer authorization relationship structure, and standardized querying with known query service result attributes, also enables greater data sharing while greatly reducing the risk of data mining by competitors.

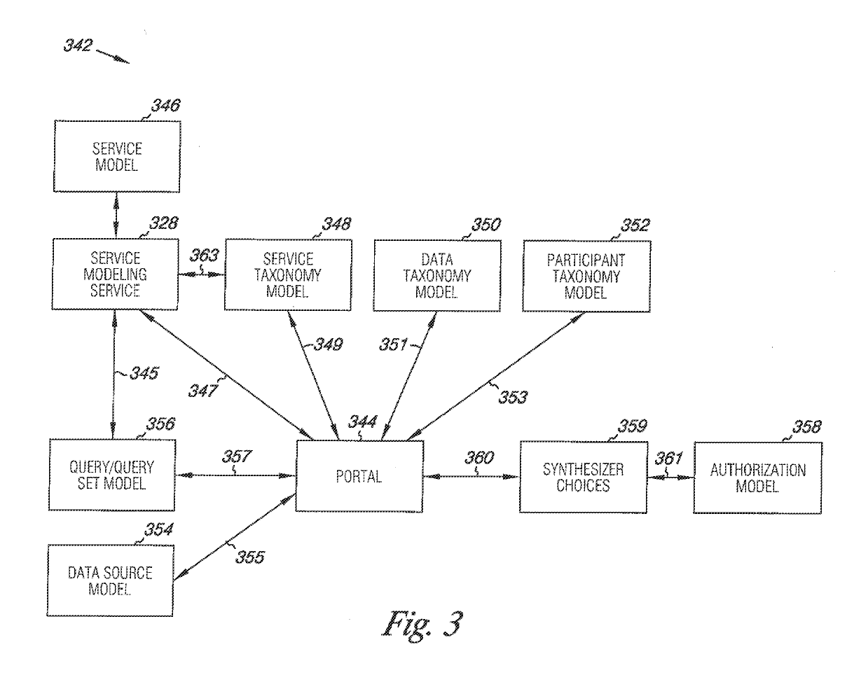

FIG. 3 is a diagram illustrating components of the collaborative information services platform according to an example of the present disclosure. A portal access system 342 includes a portal 344 communicatively coupled to a number of models and services. The portal 344 provides access to collaborative information system models that enable greater self-configuration by participants of the CIS platform (e.g., FIG. 2A at 224). Models refer to logic that may be implemented in hardware or by executable instructions stored in a memory and executable by a processor to perform a function. Participants configure models via the portal 344.

FIG. 3 shows portal 344 providing access to the service modeling service 328 via communication link 347. The service modeling service is communicatively coupled to a service model 346. An authorized service developer can use the portal 344 to manage the lifecycle of a particular service (e.g., a query service that relies on a set of one or more queries). The portal can support both human and programmatic interactions with the same level of functionality that includes the registration, categorization, and description of the service. The description of the service includes a description of the information used by the service (e.g., the queries), and the output provided by the service (e.g., the result attributes).

FIG. 3 shows portal 344 providing access to the service taxonomy model 348 via communication link 349. Participants can use the portal 344 to indicate which services in the service taxonomy model 348 they are willing to support for specific categories of data, and/or for particular locations of their data sources. The service taxonomy model 348 is communicatively coupled to the service modeling service 328 via communication link 363 such that they may exchange information. Services can be categorized to facilitate working with large numbers of services. For example, a participant may authorize a category of services instead of having to authorize a quantity of services individually. In addition, services properly added to a prior-authorized category may be authorized by virtue of the proper categorization to the authorized category.

Services can be categorized in hierarchies based on the service taxonomy model 348 that can reflect one or more of: type of service, type of result(s), and/or query/queries sets being executed to implement the service. Services can be related to other services, inherently or invoked by a participant in a related fashion (e.g., applying a logical function to the results of queries to arrive at a desired output). For example, a query service “A” may be implemented using queries that are a subset of a query service “B.” As such, query services “A” and “B” are inherently related, with query service “A” being a child of query service “B.” In another example, a participant may wish to interrogate data sources to find an output data set reflecting query service “C” AND query service “D.” In this manner, the participant invokes queries “C” and “D” in a related fashion. In yet another example a second query service may be run in the results of a first query service, such as a downstream consumer service may be run on a service to create an upstream set of data which data providers are willing to share with consumers.

The service taxonomy model 348 can be set up to be static rule based, and/or can include conditional taxonomies. For example, a data provider may be willing to share data for query service “C” run alone. The data provider may also be willing to share data for query service “D” run alone. However, the data provider may feel that the results of query service “C” AND query service “D” reveal too much information regarding the relationship of certain data in the data provider's data source. Therefore, the service taxonomy model 348 can reflect that the results of query service “C” AND query service “D” are not available at all, or that certain portions of the results are summarized to a higher level that is not so revealing, or obfuscated in some manner acceptable to the data provider. Taxonomies concerning related services can also be referred to as conditional taxonomies.

Queries themselves are described in the language(s) supported by data sources. Participants that are data source providers must enable support for such queries for a service to be able to run on their data source. Query sets are sets of queries that are often performed together, and can be authorized subject to use of an appropriate conditional taxonomy. A service (e.g., a query service, discovery service, or other service) can be implemented (e.g., use) using one or more queries, one or more query sets, or portions of one or more query sets. Several different services may have queries that belong to a particular query set. Where a participant authorizes a particular query set to involve portions of the participant's data sources, the participant may also authorize any service having queries derived entirely from the authorized particular query set. By authorizing a number of query sets, a participant can choose to authorize a wide range of services derived from the number of query sets implemented to operate on their data sources without having to evaluate (and authorize) the services individually. According to some examples of the present disclosure, a participant having a data source (e.g., data provider) can implement query sets with respect to their data source and use taxonomy model(s) to authorize services using queries of the implemented query sets. According to some examples, a participant may revoke or conditionally modify authorization of certain services despite having authorized a query set that includes each of the queries of the service. An authorization may be conditionally modified using a conditional taxonomy. For example, the relationships between individual services may be obfuscated for the presentation of data for an individual service. Therefore, a combination of two or more services (e.g., by logical operation) may not be possible without additional constraints even if the services are available individually. That is, a “composite” service may have different participation/access rights pursuant to a conditional taxonomy.

FIG. 3 shows portal 344 providing access to the query/query set model 356 via communication link 357. Participants must implement the queries and or query sets that are required for the services they choose to authorize. Implementations for query sets for particular data source products can be made available for download to participants via the Query/Query Set model 356. The query/query set model 356 is communicatively coupled to the service modeling service 328 via communication link 345, for example, to communicate to services authorization of particular queries and/or query sets.

FIG. 3 shows portal 344 providing access to the data source model 354 via communication link 355. Not all data sources will categorize data according to the data taxonomy model 350. The data source model 354 addresses this issue. If a participant's data source labels data according to the taxonomy of the data taxonomy model 350, then queries of a service are constrained based on the taxonomy of the data taxonomy model 350. Otherwise, the query and/or results are further processed to correspond the participant's data source labels to the taxonomy (e.g., according to a default mapping or list).

FIG. 3 shows portal 344 providing access to the participant taxonomy model 352 via communication link 353. The participant taxonomy model 352 defines groups of participants, such as end-consumers, growers, maintenance providers, etc. A participant may be part of zero or more groups as defined in the participant taxonomy model 352. Groups of participants can be used to further govern rights over who is permitted to invoke certain services that involve the participant's own data. That is, a participant may authorize a service to involve their data source except where the service is invoked by a specified other participant, group of participants, and/or or invoked along with (e.g., aggregated with) another service. For example, one service might provide product location information, and another service might provide product count information. A data provider may allow for other participants to run either service individually, but disallow running the two services in aggregate with one another since doing so exposes too much information (e.g., a product count at each location). Or a participant may authorize a service to involve some portion of their data source where the service is invoked by one participant/group, and may authorize a service to involve some other (more or less or different) portion of their data source where the service is invoked by another participant/group.

FIG. 3 shows portal 344 providing access to the data taxonomy model 350 via communication link 351. The data taxonomy model 350 can be configured by a participant to further define a scope of access to the participant's data source with respect to certain categories of the data, which may be further qualified by certain participants. That is, a participant may limit some (or all) portions of their data source for a particular service. For example, a participant may limit a service to involve data from their data source that is publically reported, rather than not authorize the service at all. Or a participant my limit the scope of their data source to certain relevant kinds of data for a service invoked by a specified participant, and/or subject to additional constraints with respect to combining (e.g., aggregating) services.

FIG. 3 shows portal 344 providing access to the authorization model 358 via the synthesizer choices 359 and communication links 360 and 361. A participant's configuration of one or more authorizations are synthesized into the authorization model 358, which is used to govern access to the participant's data sources. A participant's authorization configuration specification can also be captured directly into the authorization model 358. The authorization model 358 governs access to the participant's data sources by limiting the access of respective query services by authorized other participants to specified portions of the participant's data sources.

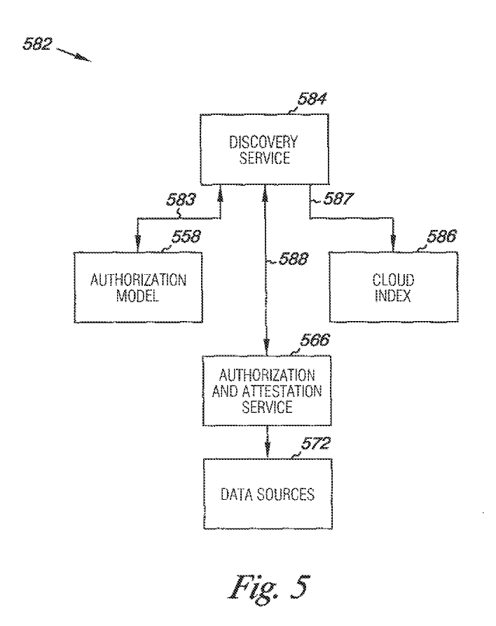

A participant-configured authorization model makes it easier for a participant (e.g., any size organization) to support their own participation in the collaborative information system than was experienced with previous (e.g., peer-to-peer) approaches where more intervention may be needed from IT staff. An example of a service that supports self-configuration for participants and the platform is the discovery service, which is discussed further with respect to FIG. 5. Like other services, the discovery service must be authorized by a participant. Once authorized for execution by the CIS platform, the discovery service peruses the service models of the participant's other authorized services, recognizes the kinds of product category and/or product IDs that are considered in the queries, and then interacts with a participant's data sources to discover which products the participant supports in its supply chain. This information is cached in a cloud index to support the efficient operation of other authorized services. It guides the other authorized query services to participant data sources that are relevant for the query service. Without such a discovery service, participants have to specifically register information they choose to authorize. Thus, self-configuration can benefit both the participant providing a data source, as well as the participant(s) that might wish to invoke services involving the data source that can function more efficiently due to the previous discovery process.

The service developer can describe a service, such as a query service, in the service model 346 using the service modeling service 328. The service developer can configure the service model 346 to indicate the queries and/or query sets that are used by a query service, for example. Participants can access the service model 346 via the portal 344 to learn the queries and/or query sets that are used by a particular query service.

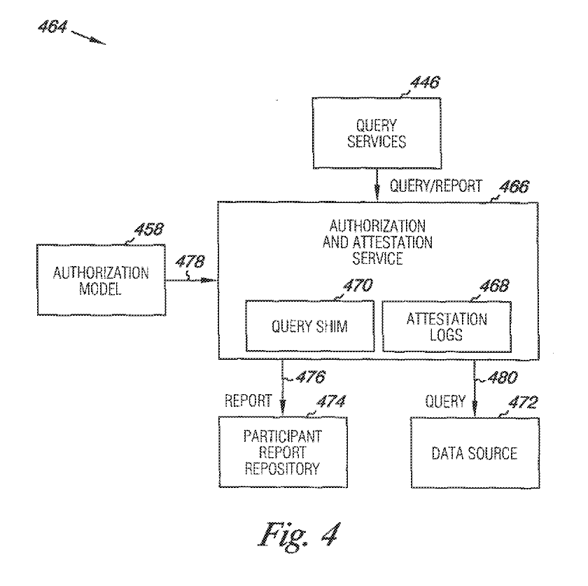

FIG. 4 is a diagram illustrating an authorization and attestation service for a computing platform according to an example of the present disclosure. Authorization logic 464 includes authorization and attestation service 466 having inputs from an authorization mod& 458 and query services 446, and providing outputs to data sources 472 and a participant report repository 474. The function of the authorization and attestation service 466 is to ensure that the CIS platform (e.g., services such as query services 446) perform authorized queries, for authorized participants, involving authorized data sources, and does not perform unauthorized queries, queries involving unauthorized portions of data sources for a respective query, and/or queries invoked by unauthorized entities (including unauthorized participants).

In addition, another function of the authorization and attestation service 466 is to maintain attestation logs 468 that can be used to audit interactions between participants and the platform and/or data sources. The authorization and attestation service can log queries and/or service invocations, among other activities that may be of interest, and can report results to participants and/or system administrators. According to one example embodiment, reports are stored in a participant report repository 474 via communication link 476.

The authorization and attestation service is guided by the authorization models 458 as may be self-managed by each participant, including service relationship rules expressed in a conditional taxonomy, as previously discussed. The authorization models 458 communicate with the authorization and attestation service 466 via a communication link 478. The authorization and attestation service 466 can include a query shim 470, a “shim” in the sense of being logic that fits between two other logic components so as to relate them (e.g., facilitate communication of useful information therebetween). The query shim 470 is programmed to ensure that just authorized queries are made upon data sources 472 (e.g., via communication link 480), and that just authorized results are returned to the invokers of services. Authorized results may not include raw data from the data sources, or intermediate results (e.g., results computed from the raw data) in response to invoking a service. Authorized results returned to a participant may format, organize, and/or summarize query raw data and/or intermediate results into higher-level authorized results that aggregate the raw data and/or intermediate results in order to maintain confidentiality of individual raw data, according to the service description. In this way, the raw data from a data source and computed intermediate results are not exposed to an invoker of a service unless they are included in the definition of results for a particular service. Thus, a data source provider is always aware of what data will be returned to an invoker of a service and can use the knowledge to direct its own authorization choices.

FIG. 5 is a diagram illustrating a discovery service for a computing platform according to an example of the present disclosure. Discovery logic 582 includes the discovery service 584 communicatively coupled to the authorization model 558 via communication link 583, and communicatively coupled to the authorization and attestation service 566 via communication link 588, and communicatively coupled to an index service 586 (e.g., a cloud index service) via communication link 587. The discovery service 584 inspects the authorization model 558 to find what services are authorized by a participant. The services authorized by a participant are determined from the authorization and attestation service 566.

The discovery service 584 also inspects the queries of services and builds information regarding the kinds of master and transactional data that may be accessed from a participant's data sources 572. According to some examples of the present disclosure, master data can concern groups of items (e.g., classifications), whereas transaction data can concern individual items. For example with respect to a collaborative information service applied in regards to a supply chain, master data might concern attributes corresponding to various kinds of stereo equipment, but the discovery service might also discover transactional data such as the actual instances of stereo equipment in the data sources and activities (e.g., sale, fabrication steps, locations, data of manufacture, component types/sources, etc.) involving the actual instances of stereo equipment.

The discovery service 584 can then run queries to the participant's data sources 572, if authorized by respective participants, to find out what kinds of corresponding master and transactional data are actually present. The information that results from the discovery service 584 is cached in a collaborative information system index (e.g., a cloud index) 586, which can be subsequently used to support the more efficient (e.g., optimized) execution of query services. For example with respect to a collaborative information service applied in regards to a supply chain, a query service is invoked by a participant to operate on a particular brand of stereo components across a number of data sources. However, since the services are defined before they are invoked by a participant, the discovery service 584 may have previously run the queries comprising the service being invoked and cached the results in the cloud index 586. Then, in response to the service being invoked by a participant causing the queries, the cache can be used to quickly find which supply chain participants have such components, rather than having to query a large quantity of possible data sources in real time.

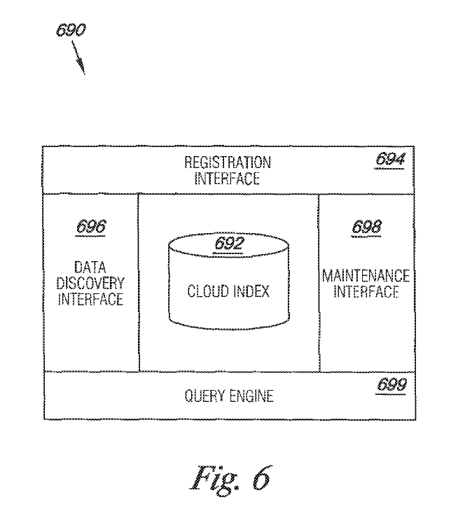

While a single cloud index is indicated in FIG. 5 for clarity, examples of the present disclosure are not so limited. That is, the collaborative information system of the present disclosure can include more than one cloud index, and/or cloud index caching arrangement (e.g., a cloud index and associated interfaces and supporting data processing hardware and/or programmed functionality, as is further discussed with respect to FIG. 6 below).

FIG. 6 is a diagram illustrating a cloud index cache arrangement according to an example of the present disclosure. The cloud index cache arrangement 690 includes a cloud index 692 communicatively coupled to each of a registration interface 694, a data discovery interface 696, a maintenance interface 698, and a query engine 699. The cloud index cache arrangement 690 supports the collaborative information services. As discussed above, the data discovery service (e.g., FIG. 5 at 584) populates the cloud index 692 with discovered information that can be used to optimize the execution of query services, for example, via a data discovery interface 696. The registration interface 694 and maintenance interface 698 may be standardized interfaces for configuring and managing the cloud index 692 respectively. The query engine 699 can be used to execute queries to populate and/or update the cloud index as may be directed by the data discovery service (e.g., FIG. 5 at 584).

A query shim (e.g., FIG. 4 at 470) can also interact with the cloud index 692 to obtain a list of data sources that may have data of interest to a query. The query shim ensures that only those data sources that have authorized the queries for the particular instance of a query service are able to provide data for the query service. Similarly, the query shim may interact with a number of cloud indexes as supported by different instances of the collaborative information services platform.

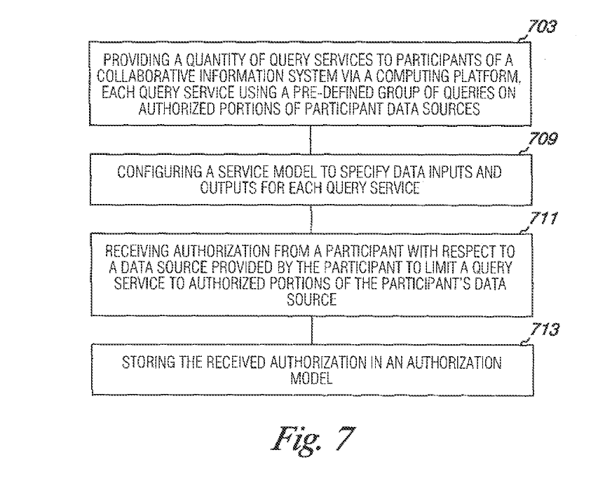

FIG. 7 is a flow chart illustrating an example of a method for a collaborative information system 701 according to an example of the present disclosure. The method 701 includes providing a quantity of query services to participants of a collaborative information system via a computing platform, each query service using a pre-defined group of queries on authorized portions of participant data sources 703. The method further includes configuring a service model to specify data inputs and outputs for each query service 709. The authorization is received from a participant with respect to a data source provided by the participant to limit a query service to authorized portions of the participant's data source 711. The method also includes storing the received authorization in an authorization model 713.

The above specification, examples and data provide a description of the method and applications, and use of the system and method of the present disclosure. Since many examples can be made without departing from the spirit and scope of the system and method of the present disclosure, this specification merely sets forth some of the many possible embodiment configurations and implementations.

Although specific examples have been illustrated and described herein, those of ordinary skill in the art will appreciate that an arrangement calculated to achieve the same results can be substituted for the specific examples shown. This disclosure is intended to cover adaptations or variations of one or more examples of the present disclosure. It is to be understood that the above description has been made in an illustrative fashion, and not a restrictive one. Combination of the above examples, and other examples not specifically described herein will be apparent to those of skill in the art upon reviewing the above description. The scope of the one or more examples of the present disclosure includes other applications in which the above structures and methods are used. Therefore, the scope of one or more examples of the present disclosure should be determined with reference to the appended claims, along with the full range of equivalents to which such claims are entitled.

Various examples of the system and method for collaborative information services have been described in detail with reference to the drawings, where like reference numerals represent like parts and assemblies throughout the several views. Reference to various examples does not limit the scope of the system and method for displaying advertisements, which is limited just by the scope of the claims attached hereto. Additionally, any examples set forth in this specification are not intended to be limiting and merely set forth some of the many possible examples for the claimed system and method for collaborative information services.

Throughout the specification and claims, the meanings identified below do not necessarily limit the terms, but merely provide illustrative examples for the terms. The meaning of “a,” “an,” and “the” includes plural reference, and the meaning of “in” includes “in” and “on.” The phrase “in an embodiment,” as used herein does not necessarily refer to the same embodiment, although it may.

In the foregoing Detailed Description, some features are grouped together in a single embodiment for the purpose of streamlining the disclosure. This method of disclosure is not to be interpreted as reflecting an intention that the disclosed examples of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A computing system, comprising:
a plurality of collaborative information participants [238] interconnected via a communication network [239], each participant having zero or more data sources [240];
a computing platform [224] programmed with query services [226], each query service defining one or more queries [227-1, 227-2, . . . , 227-N] operable on authorized portions of participant data sources [240];
wherein the computing platform [224] is further programmed with indications from individual ones of the plurality of collaborative information participants [238] authorizing some portion of their data sources [240] to be available to the one or more queries [227-1, 227-2, . . . , 227-N] used by at least one query service [226].

2. The computing system of claim 1, wherein each query service [226] specifies information that is output in response to the used one or more queries [227-1, 227-2, . . . , 227-N].

3. The computing system of claim 1, wherein the computing platform is further programmed with an authorization service [232] that is functional to prevent access to participant data sources [240] to other than the one or more queries [227-1, 227-2, . . . , 227-N] used by respective query services [226].

4. The computing system of claim 3, wherein the authorization service [232] is further functional to prevent access to any portion of a participant data source [240] that has not been authorized by the participant [238] as being available corresponding to the one or more queries [227-1, 227-2, . . . , 227-N] used by at least one query service [226].

5. The computing system of claim 1, wherein the computing platform is further programmed with an attestation service [232] configured to log interactions involving participant data sources [240].

6. The computing system of claim 1, wherein the computing platform is further programmed with a computing system index service [234] configured to maintain a cache of information obtained from authorized portions of participant data sources [240] corresponding to individual query services [226] that use one or more queries [227-1, 227-2, . . . , 227-N] operable on a small percentage of participant data sources [240].

7. The computing system of claim 1, wherein the computing platform is further programmed with indications from individual ones of the plurality of participants [238] authorizing some portion of their data sources [240] be available to one or more query sets used by at least one query service [226].

8. The computing system of claim 7, wherein the one or more query sets include all of the one or more queries [227-1, 227-2, . . . , 227-N] used by at least one query service [226].

9. The computing system of claim 8, wherein the at least one query service [226] are categorized in hierarchies defined by a service taxonomy model [348] based on a type of service, type of results, and/or one or more sets of queries that are performed together.

10. The computing system of claim 1, wherein the computing platform [224] is further programmed with indications from individual ones of the plurality of participants [238] revoking authorization of some portion of their data sources [240] available to one or more queries [227-1, 227-2, . . . , 227-N] implemented by at least one query service [226] where a plurality of related query services [226] are invoked.

11. A method for a collaborative information system [701], comprising:
providing a quantity of query services to participants of a collaborative information system via a computing platform, each query service using a pre-defined group of queries on authorized portions of participant data sources [703];
configuring a service model to specify data inputs and outputs for each query service [709];
receiving authorization from a participant with respect to a data source provided by the participant to limit a query service to authorized portions of the participant's data source [711]; and
storing the received authorization in an authorization model [713].

12. The method of claim 11, further comprising constraining, via an authorization and attestation service [232], each query service [226] to involve no more than the authorized portions of the participant's data source [240] according to the authorization model [358], and to use no more than the pre-defined group of queries.

13. The method of claim 11, further comprising logging, via a authorization and attestation service [232], interactions between each of the plurality of data sources [240] and the computing platform [224], and store reports thereof in a repository [474].

14. The method of claim 11, further comprising configuring a participant taxonomy model logic [352] to define groups of participants [238] that are permitted to invoke certain ones of the quantity of query services [226] that are further constrained to involve no more than particular ones of the plurality of the participant's data sources [240].

15. A non-transitory computer-readable medium [107] having computer-readable instructions stored thereon that, if executed by one or more processors, cause the one or more processors to provide:
a number of query services [226], each query service [226] using a number of queries [227-1, 227-2, . . . , 227-N] operable on a plurality of data sources [240];
a service modeling service [228] to configure, before invocation, data inputs and result output attributes for each query service [226];
an authorization configuration service [230] to configure participant authorization of the number of query services [226];
an authorization service [232] to constrain access to the plurality of data sources [240] to those queries used by authorized query services involving authorized portions as indicated by a participant controlling the data source [240]; and
an index service 234 to configure an index [586, 692] to store information corresponding data sources [240] to the number of queries [227-1, 227-2, . . . , 227-N].
